(19) United States
(12) Patent Application Publication
(10) Pub. No.: US 2020/0288670 A1
(43) Pub. Date: Sep. 17, 2020

(54) CANINE PAW SELF-GROOMING APARATUS

(71) Applicant: Jillian DeMichael, Seattle, WA (US)

(72) Inventor: Jillian DeMichael, Seattle, WA (US)

(21) Appl. No.: 16/298,943

(22) Filed: Mar. 11, 2019

(51) Int. Cl. A01K 15/02; A01K 13/00; A45D 29/04

(52) U.S. Cl. CPC A01K 15/024; A01K 13/00; A45D 2029/045; E05Y 2900/132; E05Y 2201/606; A45D 29/04

(57) ABSTRACT

The disclosure presented herein relates to a canine paw-grooming device that is specially adapted to cause a dog to be likely to interact with said device. The present invention is door-mounted dog paw-grooming station. Because dogs do not have an instinctual drive to groom their own nails, the mere provision of a grooming station is insufficient to induce a dog to actually use such a device. The present invention takes advantage of many dogs' tendency to paw or scratch at doors repeatedly. By securely affixing an abrasive surface to an area that a dog is likely to scratch, a dog can be induced to file its own nails in a predictable and repeatable way.

### FIELD OF THE DISCLOSURE

The overall field of invention is household pet grooming products.

### BACKGROUND

This invention relates generally to an apparatus for canine paw and nail self-grooming.

House pets have an array of grooming needs. Among them are paw and nail maintenance. Some house pets, such as cats, have an instinctual drive to maintain their nails or claws, and the simple provision of a scratching post or surface is sufficient for many cats to maintain their nail health.

In contrast, dogs do not tend to have an instinct for nail maintenance. While some dogs may occasionally bite or chew at their nails, in general, the responsibility falls to a dog's owner to clip or shorten their dog's nails to a healthy length. Dog nail length can be maintained by allowing a dog to walk and run on rough surfaces such as concrete for extended periods, and therefore owner intervention can be reduced or eliminated via these means. However, for many dog owners, this method is impractical, and thus active intervention is required. For many dog owners, dog nail maintenance requires shortening the dog's nails with clippers, or hiring a professional groomer to do the same, due to the difficulty of the procedure.

A need exists for a device that will groom or shorten a pet dog's nails without the need for any significant intervention by the dog's owner.

### SUMMARY

The disclosure presented herein relates to a canine paw-grooming device that is specially adapted to cause a dog to be likely to interact with said device. The present invention is door-mounted dog paw-grooming station. Because dogs do not have an instinctual drive to groom their own nails, the mere provision of a grooming station is insufficient to induce a dog to actually use such a device. The present invention takes advantage of many dogs' tendency to paw or scratch at doors repeatedly. By securely affixing an abrasive surface to an area that a dog is likely to scratch, a dog can be induced to file its own nails in a predictable and repeatable way. The device is adapted to securely mount the abrasive surface on the lower interior surface of a door, such that when a dog scratches at the door, the dog will scratch the abrasive and effectively groom its own nails. The invention has the highly beneficial secondary effect of protecting the door from dog scratch damage. An additional secondary benefit of the device relates to the amplification of the scratching sound that results from a dog scratching at an abrasive surface as opposed to a generally smoother unprotected door surface. By amplifying the scratching sound, the device allows a dog to more easily alert owners to the pet's communications or needs.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 shows a perspective view of an embodiment of the device.

FIG. 2 shows a front view of an embodiment of the device.

FIG. 3 shows a section view of an embodiment of the device.

FIG. 4 shows a detail of a lower portion of the section view of the device.

FIG. 5 shows a detail view of an upper portion of the section view of the device.

FIG. 6 shows a rear perspective view of the device.

FIG. 7 shows a front view of an embodiment as installed on a standard door.

FIG. 8 shows a perspective view of an embodiment as installed on a standard door.

### DETAILED DESCRIPTION

In the Summary above, this Detailed Description, the claims below, and the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

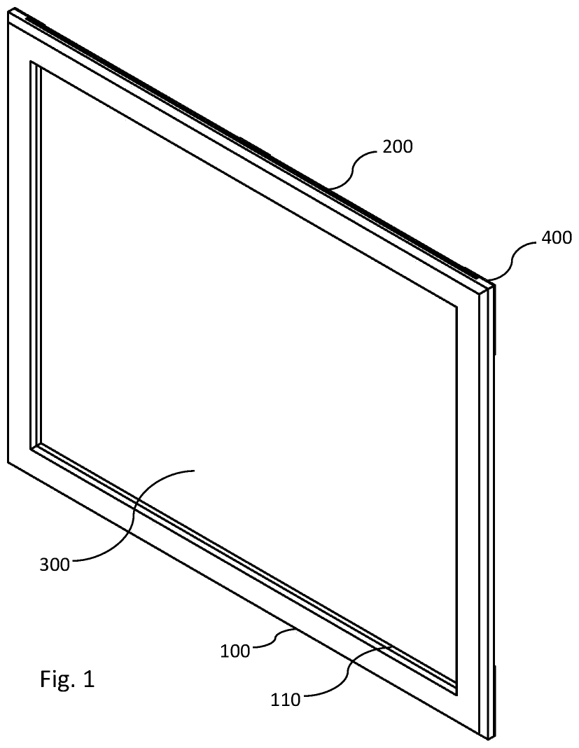

FIG. 1 shows a perspective view of an embodiment of the device. The device comprises a front frame 100, a backer board 200, an abrasive sheet 300, and an affixation means 400. In the embodiment the front frame 100 and backer board 200 are substantially rectangular and of similar size. The backer board 200 comprises a substantially rigid planar rectangular surface for underlayment of the abrasive sheet 300. The backer board functions to provide the structural strength to resist and protect a door from a dog scratching at the device. The front frame 100 is a substantially rectangular frame that covers the periphery of the abrasive sheet, while also forming a large central opening 110 that exposes a large portion of the front of abrasive sheet to the environment. In the preferred embodiment, the front frame 100 and the backer board are integrally formed as a single molding. In alternative embodiments, the front frame 100 and backer board 200 are separate parts that are then joined to form a whole. Similarly, the front frame may be comprised of one or more components. In the preferred embodiment the front frame is a single continuous molding, while alternative embodiments may comprise multiple individual members that are joined to form the whole.

The front frame 100 in combination with the backer board 200 serve to retain the abrasive sheet in a substantially fixed position. In order to present a suitably large surface for canine interaction with the device, the device should cover an area that is likely to be scratched by a dog. In the preferred embodiment, the device covers nearly the entire width of a door, with standard doors typically being between 30 and 36 inches in width. Therefore, the preferred width of the device is between 30 and 36 inches. In alternative embodiments, the device may cover a smaller area, as dogs will often tend to bias their scratching toward the latch-side of the door, and a smaller width, such as 12-18 inches may be suitable in these circumstances. Similarly, dog scratching tends to occur at a height lower than the doorknob, which are generally installed between 34 and 48 inches from the lower edge of the door. Therefore, the preferred height of the device is approximately 30 inches, though larger or smaller sized may be suitable for differing door dimensions or dog sizes.

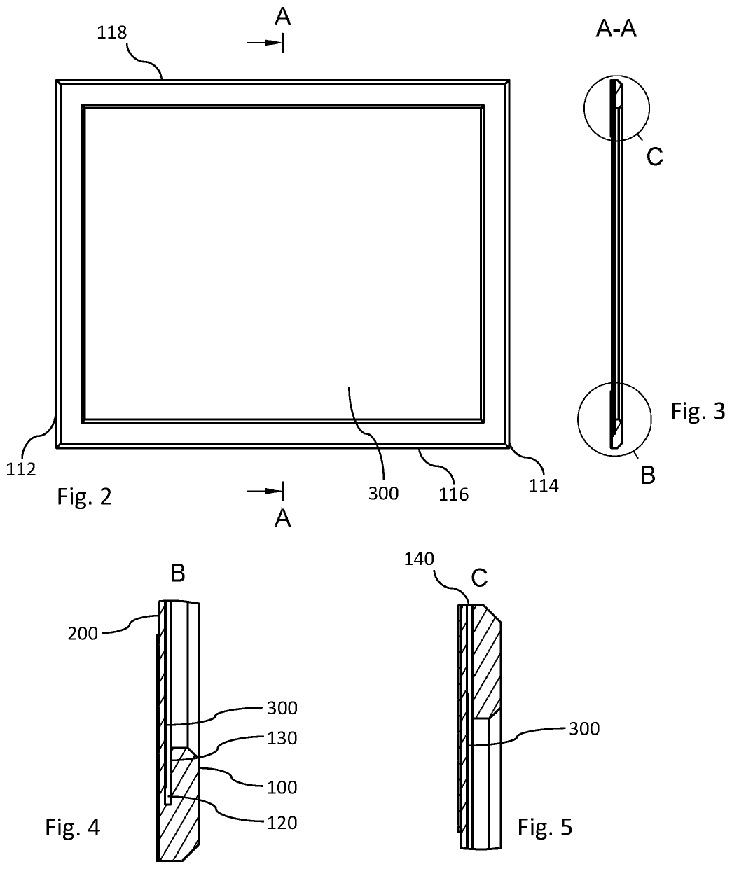

FIG. 2 shows a front view of an embodiment of the device. In the embodiment, the abrasive sheet 300 is a rectangular sheet having vertical, horizontal, and thickness dimensions. In an embodiment, the abrasive sheet is sandpaper. In the preferred embodiment the abrasive sheet comprises a foam core having abrasive material on both front and back surfaces similar to a traditional nail-filing emery board. In the preferred embodiment the front and rear sides of the abrasive sheet will have differing grits, such that there is a coarse side and a fine side. In alterative embodiments, the abrasive sheet is a pumice stone slab. Differing abrasive sheets will have differing effects related to grooming. In an embodiment, low grit sandpaper such as 40 or 60 grit paper may be used to aggressively remove excess nail length. In alternative embodiments, higher-grit sandpaper, such as 150 or 200 grit paper may be used when nail-shaping is preferred to nail shortening. Furthermore, paw pad exfoliation can be achieved by providing an appropriate grit paper. Users are able to select and use a level of abrasiveness that suits their dog-grooming needs. The abrasive sheet will tend to be consumable through use. Therefore, the device design is adapted to allow a user to easily replace sheets once worn.

Abrasive sheets are retained in a receptacle formed between the front frame and the backer board. The front frame and backer board are joined along the left 112, right 114, and lower edges 116, effectively capturing the abrasive sheet in those directions. The front frame is relieved from the backer board along the top edge 118, forming a slot that is nominally wider than the width of the abrasive sheet and nominally thicker than the thickness of the abrasive sheet. Therefore the abrasive sheet can be inserted and removed through the slot at the top edge of the device. Similarly, an inner portion of the left, right, and lower members of the front frame are similarly relieved from the backer board, thus allowing the abrasive sheet to be inserted behind a portion of each member of the front frame, thereby retaining the abrasive sheet in position for use. In other words, a portion of each member of the front frame extends over a portion of the abrasive sheet, preventing its removal through the central opening 110, which would be dimensionally smaller than the abrasive sheet 300 in the vertical and horizontal dimensions. In an embodiment, the slot thickness is great enough to accommodate multiple sheets for abrasive sheet storage. The preferred embodiment employs a dual-sided foam core for the abrasive sheet having a thickness of 0.22-0.25 inch in thickness. In alternative embodiments the abrasive sheet is sandpaper, which can vary in thickness substantially from specimen to specimen. As such, the thickness of the slot should be adapted to accommodate the particular intended abrasive sheet thickness, with the preferred slot and receptacle thickness being approximately 0.25 inches, though thicknesses between 0.020 and 0.375 may be desirable depending upon the particular dimensions of the chosen abrasive sheet. In alternative embodiments having pumice stone as the abrasive sheet, the thickness of the slot should be adapted to accommodate a specific specimen size of pumice stone. For example, if the abrasive sheet is a slab of pumice stone having thickness of approximately 0.5 inches, then the receptacle and slot should be nominally larger than 0.5 inches. In embodiments having sandpaper as the abrasive sheet, the sandpaper can use any suitable abrasive compound, though any of garnet, emery, aluminum oxide, silicon carbide, zirconia alumina, or ceramic alumina abrasives are suitable.

FIG. 3 shows a section view of an embodiment of the device.

FIG. 4 shows a detail of a lower portion of the section view of the device. The view shows detail related to the receptacle 120 that is formed between the front frame 100 and the backer board 200 to capture the abrasive sheet 300 through and a relief 130 that causes the front frame to extend over the peripheral edges of the abrasive sheet 300 in order to retain it against the backer board 200.

FIG. 5 shows a detail view of an upper portion of the section view of the device. The view details the relief that extends through the entirety of the upper member of the front frame, forming the slot 140 through which the abrasive sheet is inserted and removed.

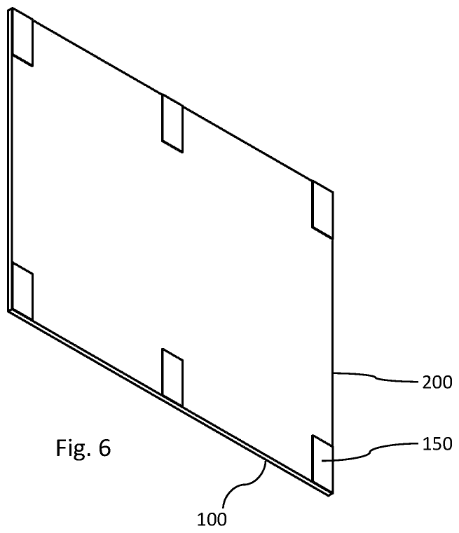

FIG. 6 shows a rear perspective view of the device. In an embodiment, the device is affixed to a door through use of double-sided adhesive 150, such as mounting tape. Alternatively, the device may be affixed using any other suitable affixation or fastening means, including but not limited to screws, nails, staples, brads, rivets, liquid adhesive, mounting brackets, or any other fastening or affixation capable of supporting the weight of the device and resisting forces applied during use.

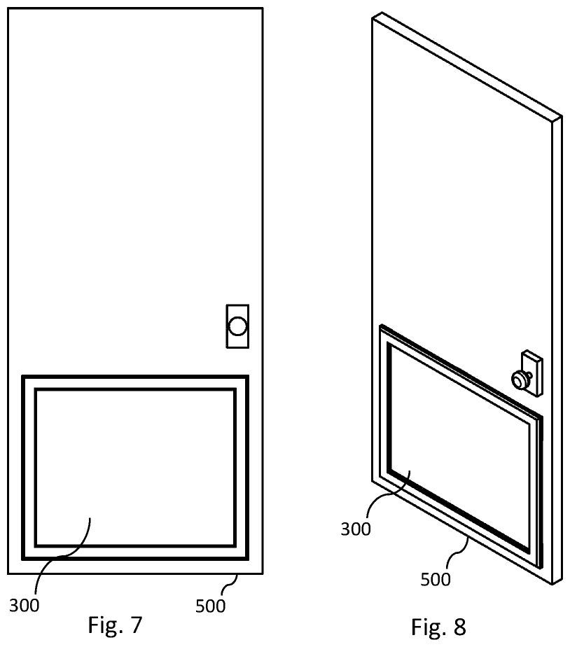

FIG. 7 shows a front view of an embodiment as installed on a standard door 500.

FIG. 8 shows a perspective view of an embodiment as installed on a standard door 500. The device is designed to be positioned to cover a large portion of the lower area of the door, and further to present the abrasive sheet 300 to a dog that approaches the door.

While preferred and alternate embodiments have been illustrated and described, as noted above, many changes can be made without departing from the spirit and scope of the invention. Accordingly, the scope of the invention is not limited by the disclosure of these preferred and alternate embodiments. Instead, the scope of the invention should be determined entirely by reference to the claims. Insofar as the description above and the accompanying drawings disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

We claim:

1. A canine self-grooming device comprising:
an abrasive sheet having a front face and a back face, said front face being substantially covered by an abrasive material,
a backer board having top, left, right, and bottom edges, a front face, and a back face, said backer board being adapted for affixation to a lower interior portion of a standard household door, and
a front frame comprising top, left, right, and bottom members joined at their ends to form a rectangular frame having a central opening and outer edges, said front frame left, right, and bottom members being joined at corresponding outer edges to said backer board along said corresponding backer board edges, said front frame members being relieved from said backer board proximal to said central opening forming a receptacle adapted to receive and retain said abrasive sheet, said receptacle extending through the extent of said front frame top member forming a slot between said front frame top member and said backer board through which said abrasive sheet can be inserted.

2. The device of claim 1, further comprising:
a fastening means adapted to affix said backer board to said door.

3. The device of claim 1, further comprising:
a portion of double-sided adhesive mounting tape adhered to said back face of said backer board.

4. The device of claim 1, further comprising:
a plurality of fasteners for fastening the back surface of the backer board to the surface of a door.

5. The device of claim 1, wherein said abrasive sheet is sandpaper.

6. The device of claim 5, wherein said sandpaper has a grit number between 20 and 320.

7. The device of claim 6, wherein said sandpaper has an abrasive of garnet, emery, aluminum oxide, silicon carbide, zirconia alumina, or ceramic alumina.

8. The device of claim 1, wherein said abrasive material is pumice stone.

9. A canine self-grooming device comprising:
a rectangular abrasive sheet having a height, a width, a thickness, a front face and a back face, said front face being substantially covered by an abrasive material,
a rectangular backer board having top, left, right, and bottom edges, a front face, and a back face, said top and bottom edges being between 12 and 36 inches in length, said left and right edges being between 20 and 36 inches in length, and
a rectangular front frame comprising top, left, right, and bottom members joined at their ends to form a rectangular frame having a central opening and outer edges, said front frame left, right, and bottom members being joined to said backer board along corresponding of said front frame edges to said corresponding backer board edges, said front frame members being relieved from said backer board proximal to said central opening forming a receptacle having a height, width, and thickness, said receptacle being adapted to receive and retain said abrasive sheet, said receptacle thickness being between 0.020 inches and 0.375 inches, said receptacle extending through the extent of said front frame top member forming a slot between said front frame top member and said backer board front face, said receptacle height, width, and depth having dimensions that are larger than the corresponding dimensions of said abrasive sheet, said central opening having a height and width wherein said central opening height and width dimensions are smaller than the corresponding dimensions of said abrasive sheet.

10. The device of claim 9, further comprising:
a plurality of portions of double-sided adhesive mounting tape adhered to said back face of said backer board and adapted to adhere to a surface of a standard door.

11. The device of claim 9, further comprising:
a means for affixing said backer board to a standard door.

12. The device of claim 9 wherein said top and bottom edges are between 24 and 34 inches in length.
